(19) United States
(12) Patent Application Publication
(10) Pub. No.: US 2017/0286442 A1
(43) Pub. Date: Oct. 5, 2017

(54) FILE SYSTEM SUPPORT FOR FILE-LEVEL GHOSTING

(71) Applicant: MICROSOFT TECHNOLOGY LICENSING, LLC, Redmond, WA (US)

(72) Inventors: PING XIE, REDMOND, WA (US); RAN KALACH, BELLEVUE, WA (US); RAJ DAS, KIRKLAND, WA (US); TOM JOLLY, REDMOND, WA (US); ARUSHI AGGARWAL, SEATTLE, WA (US)

(21) Appl. No.: 15/198,587

(22) Filed: Jun. 30, 2016

Related U.S. Application Data
(60) Provisional application No. 62/315,996, filed on Mar. 31, 2016.

(51) Int. Cl. G06F 17/30

(52) U.S. Cl. CPC G06F 17/30156; G06F 17/30138; G06F 17/30221

(57) ABSTRACT

File system-awareness of ghosting performed by one or more tiering engines allows a file system to receive and store metadata indicating an identifier of the tiering engine ghosting the file extents and a storage location of the ghosted file extents for later use by the tiering engine. The file system is able to receive and process requests to read and write to a file having ghosted extents.

### CROSS REFERENCE TO RELATED APPLICATIONS

This application claims the benefit of priority from U.S. Patent Application No. 62/315,996, filed Mar. 31, 2016, the contents of which are incorporated by reference herein in their entirety for all purposes.

### BACKGROUND

In computing, a file system manages the storage and retrieval of files and stores the data of each file in one or more data streams in the storage local to the file system. A ghosting process, e.g., deduplication or cloud tiering, may move a range or extent of data of a file to a location outside of its one or more data streams. The new storage location for the ghosted extent typically is managed by a tiering engine and is not known by the file system.

### SUMMARY

In existing deduplication and cloud tiering implementations, the management of metadata concerning ghosted extents of data is performed by an entity, commonly referred to as a tiering engine, that sits above the file system of the underlying computer system; the file system is not aware of any ghosted extents. This can lead to inefficiencies in data access by a user application.

Aspects of the present disclosure enable file system-awareness of ghosting performed by one or more tiering engines. A file system may manage the storage and retrieval of files and store the data of each file in one or more data streams. The file system may also maintain, for each of a plurality of files managed by the file system, metadata concerning one or more ranges (i.e., extents) of data of the file, the metadata including, for each range of data stored within the storage local to the file system, an indication of the storage location of the range of data within the local storage. The file system may receive from a tiering engine, a request indicating that a range of data of one of the files managed by the file system is stored by the tiering engine, not within the one or more data streams of the file, in a location known and managed by the tiering engine, the request comprising an identification of the range of the data and an identifier associated with the tiering engine. In response to the request, the file system may store within the metadata maintained by the file system, for the identified range of data, an indication that the range of data is not stored within the one or more data streams of the file, i.e., that it is ghosted, and the identifier of the tiering engine from which the request was received. Aspects disclosed herein enable a file system to receive and process requests to read a file in which one or more extents have been ghosted, and to return the stored metadata for any ghosted extents to the appropriate tiering engine. Aspects disclosed herein also enable a file system to receive and process requests to write to or delete a file in which one or more extents have been ghosted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. In the drawings:

FIG. 1 illustrates an exemplary operating environment, in which the aspects disclosed herein may be employed;

FIG. 2A illustrates an example file layout map entry maintained by a file system;

FIG. 2B illustrates an example of the file layout map entry of FIG. 2A after ghosting of an extent has been performed;

FIG. 3A illustrates another example file layout map entry maintained by a file system;

FIG. 3B illustrates an example of the file layout map entry of FIG. 3A after ghosting of an extent has been performed;

FIG. 4A illustrates yet another example file layout map entry maintained by a file system;

FIG. 4B illustrates an example of the file layout map entry of FIG. 4A after ghosting;

FIG. 5 is a sequence diagram illustrating an embodiment of a method of ghosting a file extent;

FIG. 6 is a sequence diagram illustrating an embodiment of a method of reading a ghosted file;

FIG. 7 is a sequence diagram illustrating an embodiment of a method of writing to a file that has been at least partially ghosted; and

FIG. 8 illustrates an example architecture for implementing deduplication with a file system, in accordance with one embodiment.

### DETAILED DESCRIPTION

File systems manage the storage and retrieval of files and store the data of each file in one or more data streams. Typically, files are stored in blocks (sometimes referred to as clusters) of a volume on a storage medium local to the file system, such as a hard disk drive (HDD), solid state drive (SSD), or any other suitable storage medium. If a file is too large to fit in a single block, the file may be stored in several blocks, which may or may not be contiguous on the storage medium. For example, file A might require storage in four blocks, A[1], A[2], A[3], and A[4], and if the volume (V) has ten blocks, file A might be stored in blocks V[1], V[2], V[5], and V[9] of the volume, but not necessarily in sequential order. So, to access data maintained by a file system, the file system maintains metadata for each file that identifies for each range (i.e., extent) of data of the file the location(s) or block(s) of the storage volume in which those ranges of data are stored. This metadata is sometimes referred to as a file layout map, and it can take a variety of different forms, such as, for example, a table. For ease of description only, this metadata will be referred to hereinafter as a “file layout map.”

In one embodiment, for each file of the plurality of files managed or maintained by the file system, the file layout map stores metadata that maps each range (i.e. extent) of data of the file to a corresponding block of the storage volume on which the data is stored. To ease complexity, blocks stored in continuous sections of the storage location may be grouped together. For example, the file layout map entry for file A might contain three entries, with each entry corresponding to (and identifying) a block or range of blocks of file A and a pointer to the location of those block(s) within the volume of the storage medium on which they are stored: A[1-2] are stored in V[1-2]; A[3] is stored in V[9]; and A[4] is stored in V[5]. Notice that A[4] is stored “before” A[3] on the volume, which may happen in normal operation. Each block or range of blocks of a file may be called an “extent”. For example, A[1] may be an extent of file A, and A[1-2] may be also be an extent of file A.

As used herein, references to a computing entity “knowing” or having “knowledge” of something means that the computing entity contains information from which it can discern that something. If the computing entity does not “know” something, then it does not contain such information. For example, if a file is stored in a location that is not known by the file system, the file system does not contain information from which it can itself determine that location.

In computing, ghosting refers to the general process of moving user data out of its one or more data streams to a different location. That is, the data for the moved extent, or range, of the file is stored in a location that is not within the data stream and not known by the file system. The location may be on the same storage volume the file is stored on, on a different computer, in a cloud storage location, or any other feasible storage location. For example, two methods of ghosting are deduplication and cloud tiering.

Deduplication, also known as data optimization, is the act of reducing the physical amount of bytes of data which need to be stored on disk or transmitted across a network without compromising the fidelity or integrity of the original data. Data deduplication reduces the storage capacity needed to store data, and may therefore lead to savings in terms of storage hardware costs and data management costs. Data deduplication provides a solution for handling the rapid growth of digitally stored data.

Deduplication may be performed according to one or more techniques to eliminate redundancy within and between persistently stored files. For instance, according to one technique, unique regions of data that appear multiple times in one or more files may be identified, and only a single copy of those identified unique regions of data (also referred to as data “chunks”) may be physically stored. References to those identified data chunks may be stored to indicate the files, and the locations in the files, that include them.

Cloud tiering is similar to deduplication, except that the storage location is not located on the same storage volume of the file. Instead, the data chunks may be stored in a cloud storage location.

The term “ghosted extent” refers to an extent, or range, of data in a user file that has been moved to another location. The retrieval of the original data requires extra pieces of information which may be referred to as “ghosting metadata.” Ghosting metadata is the metadata that describes the location of the ghosted extents.

In existing systems, ghosting is performed by a tiering engine that is responsible for maintaining the ghosting metadata for ghosted extents; the underlying file system is not aware of the ghosted extents. That is, the tiering engine must maintain its own file layout map to be able to locate the data of any ghosted extents. The file system may not store any meaningful metadata in its file layout map for a ghosted extent. When the file system receives a request from a user application to retrieve a file in which one or more extents may be ghosted, the file system may return null data for the ghosted extent, leaving the tiering engine responsible to locate and retrieve the ghosted extents in order to fulfill the user application request. Additionally, with the tiering engine solely handling ghosting, the file system does not have complete knowledge of the composition of a ghosted file, and may see zero data in the file.

Aspects of the present disclosure enable file system-awareness of ghosting performed by one or more tiering engines. The file system may receive, from a tiering engine, a request indicating that a range of data, or blocks, of one of the files managed by the file system is to be ghosted, i.e., stored by the tiering engine, not within the one or more data streams of the file, in a location known and managed by the tiering engine, such as another storage volume or a cloud storage location. The request may identify the range of the file data and include an identifier associated with the tiering engine. In response to the request, the file system may modify its maintained metadata associated with the identified range of file data to include an indication that the range of file data is not stored within the one or more data streams of the file (i.e., that it is ghosted) and further include the identifier of the tiering engine from which the request was received. Storing the identifier of the tiering engine enables the file system to store metadata on a per-tiering engine basis; different tiering engines may ghost different parts of a file. Aspects disclosed herein further enable such a request from a tiering engine to include additional tiering engine metadata that reflects the storage location of the range of data not within the one or more data streams of the file. The tiering engine may later retrieve this additional metadata from the file system to locate the file data in the storage location not within the one or more data streams of the file. The file system may store this additional tiering engine metadata in the file system metadata maintained by the file system for the identified range of file data. After ghosting, the file system may free the disk space of the storage location of the identified range of data within the local storage of the file system. This free disk space may then be used to store other file data.

Further, aspects disclosed herein enable a file system to receive and process a request to read a file. More particularly, a file system may receive a request, from a client of the file system, such as a user application or ghosting engine, via the tiering engine, to read at least a portion of the contents of a file. The file system may determine, from the file system metadata which the file system maintains for the requested file, that at least one range of data of the requested portion of the file is stored by the tiering engine and not stored within the one or more data streams of the file. For this at least one range of data determined to be stored by the tiering engine and not stored within the one or more data streams of the file, the file system may return an indication of that determination to the tiering engine. The tiering engine is then responsible for retrieving the range of data not stored within the one or more data streams of the file in order to fulfill the client request. For any ranges of data of the requested portion that are stored within the one or more data streams of the file, the file system may retrieve the data of those ranges from the local storage of the file system based on the metadata maintained for those ranges by the file system and return the data of those ranges to the tiering engine.

Aspects disclosed herein also enable a file system to receive and process a request to write to a file. A file system may receive a request from a client of the file system via the tiering engine, to write to at least a portion of the contents of a file. The file system may determine, from the file system metadata which the file system maintains for the requested file, that at least one range of data of the requested portion of the file is stored by the tiering engine and not stored within the one or more data streams of the file. For this at least one range of data determined to be stored by the tiering engine and not stored within the one or more data streams of the file, the file system may return an indication of that determination to the tiering engine. The file system may then receive from the tiering engine the at least one range of data stored by the tiering engine. Then, the file system may store the at least one range of data stored by the tiering engine in the one or more data streams of the file and store, within the metadata maintained by the file system, for each of the at least one range of data, an indication that the range of data is stored within the one or more data streams of the file. The file system may then fulfill the client request and write to the contents of the file.

Aspects disclosed herein further enable a file system to receive and process a request to delete a file. More particularly, a file system may receive a request, from a client of the file system via the tiering engine, to delete the contents of a file. The file system may determine, from the file system metadata which the file system maintains for the requested file, that one or more ranges of data of the requested portion of the file are stored by at least one tiering engine and not stored within the one or more data streams of the file. For this one or more ranges of data determined to be stored by the at least one tiering engine and not stored within the one or more data streams of the file, the file system may return an indication of that determination to the at least one tiering engine. The at least one tiering engine is then responsible for deleting the range of data not stored within the one or more data streams of the file. For any ranges of data of the requested portion that are stored within the one or more data streams of the file, the file system may delete the data of those ranges from the local storage of the file system based on the metadata maintained for those ranges by the file system.

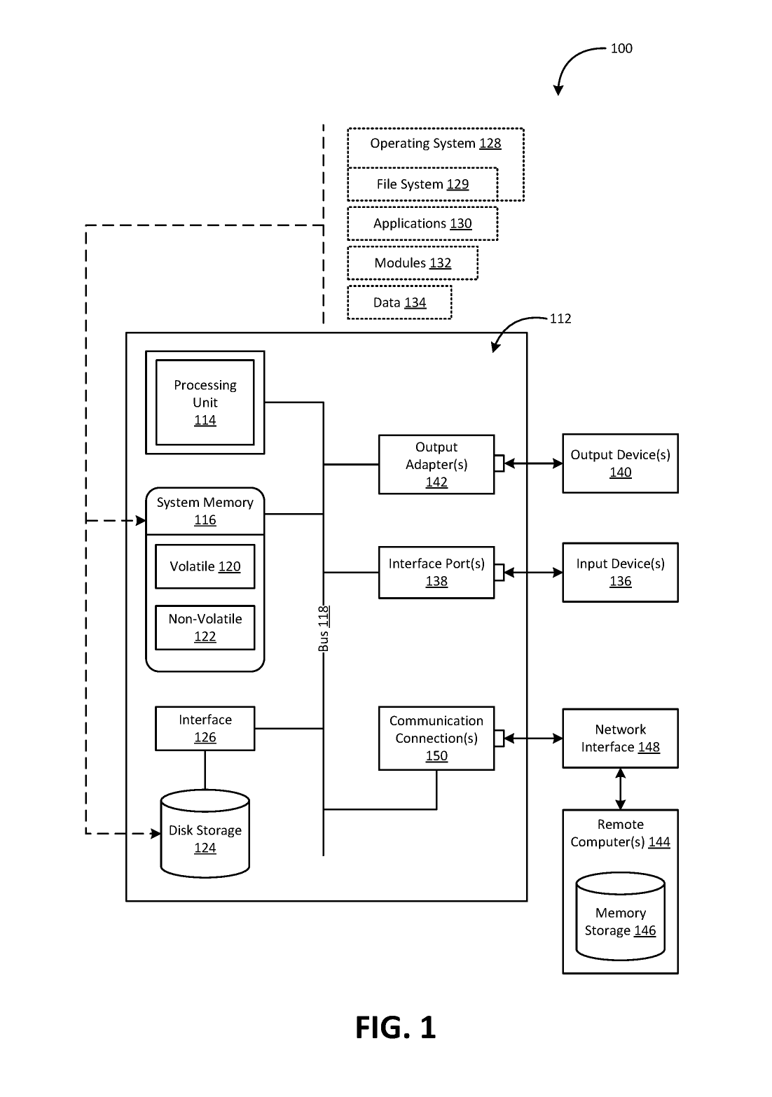

FIG. 1 illustrates an exemplary environment 100 for implementing various aspects of the disclosure. As shown, environment 100 includes a computing device 112. The computing device 112 may be any one of a variety of different types of computing devices, including, but not limited to, a computer, personal computer, server, portable computer, mobile computer, wearable computer, laptop, tablet, personal digital assistant, smartphone, digital camera, or any other machine that performs computations automatically.

The computing device 112 includes a processing unit 114, a system memory 116, and a system bus 118. The system bus 118 couples system components including, but not limited to, the system memory 116 to the processing unit 114. The processing unit 114 may be any of various available processors. Dual microprocessors and other multiprocessor architectures also may be employed as the processing unit 114.

The system bus 118 may be any of several types of bus structure(s) including a memory bus or memory controller, a peripheral bus or external bus, and/or a local bus using any variety of available bus architectures including, but not limited to, Industry Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 116 includes volatile memory 120 and nonvolatile memory 122. The basic input/output system (BIOS), containing the basic routines to transfer information between elements within the computing device 112, such as during start-up, is stored in nonvolatile memory 122. By way of illustration, and not limitation, nonvolatile memory 122 may include read only memory (ROM), programmable ROM (PROM), electrically programmable ROM (EPROM), electrically erasable ROM (EEPROM), or flash memory. Volatile memory 120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computing device 112 also includes removable/non-removable, volatile/non-volatile computer-readable storage media. FIG. 1 illustrates, for example, a disk storage 124. Disk storage 124 includes, but is not limited to, devices like a magnetic disk drive, floppy disk drive, tape drive, Jaz drive, Zip drive, LS-100 drive, memory card (such as an SD memory card), or memory stick. In addition, disk storage 124 may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 124 to the system bus 118, a removable or non-removable interface is typically used such as interface 126.

FIG. 1 further depicts software that acts as an intermediary between users and the basic computer resources described in the suitable operating environment 100. Such software includes an operating system 128. Operating system 128, which may be stored on disk storage 124, acts to control and allocate resources of the computing device 112. Applications 130 take advantage of the management of resources by operating system 128 through program modules 132 and program data 134 stored either in system memory 116 or on disk storage 124. It is to be appreciated that the aspects described herein may be implemented with various operating systems or combinations of operating systems. As further shown, the operating system 128 includes a file system 129 for storing and organizing, on the disk storage 124, computer files and the data they contain to make it easy to find and access them.

A user may enter commands or information into the computing device 112 through input device(s) 136. Input devices 136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 114 through the system bus 118 via interface port(s) 138. Interface port(s) 138 include, for example, a serial port, a parallel port, a game port, and a universal serial bus (USB). Output device(s) 140 use some of the same type of ports as input device(s) 136. Thus, for example, a USB port may be used to provide input to computing device 112, and to output information from computing device 112 to an output device 140. Output adapter 142 is provided to illustrate that there are some output devices 140 like monitors, speakers, and printers, among other output devices 140, which require special adapters. The output adapters 142 include, by way of illustration and not limitation, video and sound cards that provide a means of connection between the output device 140 and the system bus 118. It should be noted that other devices and/or systems of devices provide both input and output capabilities such as remote computer(s) 144.

Computing device 112 may operate in a networked environment using logical connections to one or more remote computing devices, such as remote computing device(s) 144. The remote computing device(s) 144 may be a personal computer, a server, a router, a network PC, a workstation, a microprocessor based appliance, a peer device, another computing device identical to the computing device 112, or the like, and typically includes many or all of the elements described relative to computing device 112. For purposes of brevity, only a memory storage device 146 is illustrated with remote computing device(s) 144. Remote computing device(s) 144 is logically connected to computing device 112 through a network interface 148 and then physically connected via communication connection 150. Network interface 148 encompasses communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 150 refers to the hardware/software employed to connect the network interface 148 to the bus 118. While communication connection 150 is shown for illustrative clarity inside computing device 112, it may also be external to computing device 112. The hardware/software necessary for connection to the network interface 148 includes, for exemplary purposes only, internal and external technologies such as modems including regular telephone grade modems, cable modems and DSL modems, ISDN adapters, and Ethernet cards.

As used herein, the terms “component,” “system,” “module,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers. Note that for data structures illustrated herein, all fields are described as little endian.

As mentioned above, present file systems do not provide native support for ghosting or maintaining ghosting metadata. Instead, file systems rely on one or more tiering engines to handle ghosting and may hold only null values in their file layout maps for the ghosted range of file data, leaving the file system without complete knowledge of the composition of a ghosted file.

Addressing these problems, aspects of the present disclosure enable ghosting metadata support to be implemented into a file system. In embodiments disclosed herein, the aspects of the present disclosure are implemented in a file system known as the Resilient File System (ReFS). However, it is understood that the aspects described herein may be applied to any file system that employs a file layout map containing metadata entries to provide information about files stored on a volume. The claimed subject matter is by no means limited to the ReFS file system, and the discussion of ReFS is by way of example only.

Interaction with a file system is possible through file system control (FSCTL) methods or commands, which may also be referred to as requests. To implement ghosting support in a file system, in one embodiment, new FSCTL methods are introduced that tiering engines may use to ghost file extents. New FSCTL methods include at least a ghosting-extents method to ghost file extents and an FSCTL query-ghosted-extents method to retrieve those ghosted file extents.

The new ghosting-extents method may be invoked by a tiering engine to ghost a file. The method may be used to ghost an entire file or a portion of a file and may be invoked any number of times, as needed, to ghost more of a file or update an already ghosted range. In one embodiment, the tiering engine must have write permissions, or FILE WRITE DATA permission in ReFS, on the specified file handle to be able to ghost ranges of data of the file. A structure supplied as input to the new FSCTL ghosting-extents method may detail which range of a file to ghost and the ghosting metadata to store within the metadata maintained by the file system for the ghosted range in the file layout map:

typedef struct _GHOST_EXTENTS_DATA {

HANDLE FileHandle;
LARGE_INTEGER FileOffset;
LARGE_INTEGER ByteCount;
ULONGLONG MetadataLength;
PVOID Metadata;

} GHOST_EXTENTS_DATA, *PGHOST_EXTENTS_DATA;

FileHandle is the file name or file identifier to be ghosted.
FileOffset indicates the file-view offset where the range to be ghosted starts.
ByteCount indicates how long that range is.
MetadataLength indicates the length of the Metadata to be placed in the file layout map.
Metadata is the ghosting metadata that is placed in the file layout map for the given range after ghosting.

On reads and writes, the tiering engine may query the file system to read at least a portion of the contents of a file. The file system may determine from the metadata for the requested range of the file whether or not the requested portion of the file is within the one or more data streams of the file or maintained by the tiering engine, not within the one or more data streams of the file, in a location known and managed by the tiering engine. For portions of the file stored within the one or more data streams of the file, the file system may use the metadata to retrieve the data and return it to the tiering engine. For portions stored by the tiering engine and not stored within the one or more data streams of the file, the file system may return the metadata to the tiering engine, which the tiering engine may then use to query its data store and retrieve the data. The metadata aides the tiering engine in mapping the ghosted range to the correct data. During writes, the tiering engine may return the ghosted data to the one or more data streams of the file after retrieving it. During deletes, a similar process is performed, but the tiering engine and file system may delete the data instead of retrieving it. In some embodiments, a tiering engine identifier is included in the Metadata parameter. In other embodiments, the tiering engine identifier is its own parameter. The tiering engine identifier may be used to uniquely identify the tiering engine performing the ghosting if the file system is moved or multiple tiering engines are using the file system because different tiering engines may ghost different parts of a file.

A similar structure to the GHOST_EXTENTS_DATA structure above may be supplied for use with a new FSCTL query-ghosted-extents method to retrieve the metadata maintained by the file system for a file in its file layout map. However, the Metadata variables would be sent empty to the file system, and the file system would assign the Metadata and MetadataLength variables to the values stored in the file layout map. Other embodiments may use different parameters for a similar result.

In ReFS, files are a byte-based virtual view of blocks. The first byte of a file, at offset 0, is mapped to some block in the volume via metadata in a file layout map. The ReFS term for file layout maps is “run tables.” Run tables use the virtual cluster number—the file's block number —as the key and the logical cluster number—the storage location's block number—as the value. The value may also include information such as the checksum of a given file extent. To support ghosting, ReFS utilizes a new type of mapping for a range in the file layout map, which allows the file layout map to map a file extent range to the ghosting metadata supplied by the tiering engine. A ghosting operation updates the file extent range that is being ghosted to free any blocks that were currently allocated to this range and stores the ghosting metadata provided by the tiering engine instead of storing metadata containing logical cluster numbers. Ghosting in ReFS is cluster-aligned, meaning that ghosting operations take place on cluster boundaries, and cluster size is a fixed property of the storage location on which the files reside.

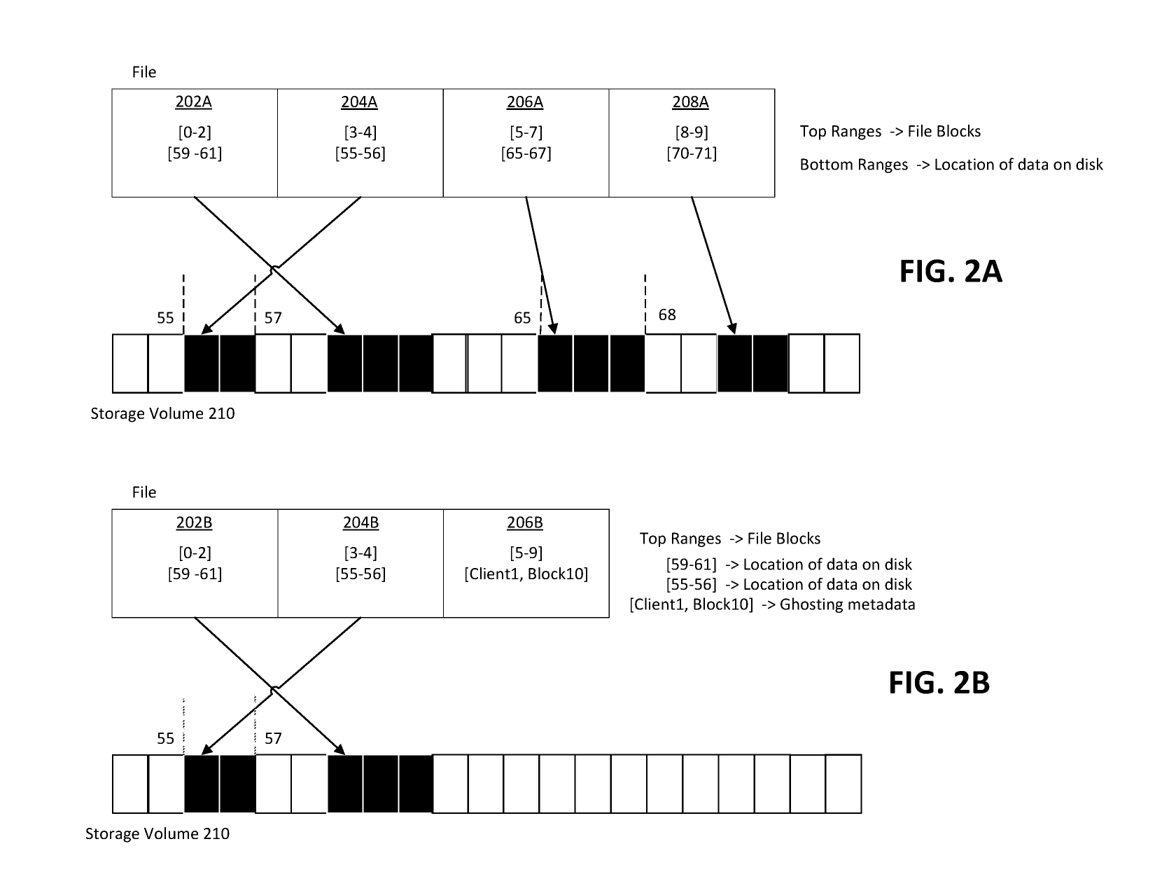

FIGS. 2A and 2B illustrate a file system's file layout map before and after ghosting a file, respectively, in accordance with one embodiment. In both figures, the top row of blocks represents a file layout map maintained by a file system for a file having at least nine blocks, and the bottom row of blocks represents a storage volume (SV) 210 where the file blocks may be stored. In FIG. 2A, file layout map entry 202A contains metadata mapping file blocks [0-2] to SV[59-61], entry 204A contains metadata mapping file blocks [3-4] to SV[55-56], entry 206A contains metadata mapping file blocks [5-7] to SV[65-67], and entry 208A contains metadata mapping file blocks [8-9] to SV[70-71]. In the present example, a ghosting operation, such as the FSCTL ghosting-extents method introduced above, is performed by a tiering engine named “Client1” that ghosts file blocks [5-9]. The tiering engine will store the ghosted extents in a location outside of the knowledge of the file system. In this example, the tiering engine may refer to that location as “Block10”. During the ghosting operation, the file system receives a request from the tiering engine indicating the range of data of the file to be ghosted ([5-9]), the tiering engine's identifier (Client1), and in this example, metadata describing the storage location of the ghosted extents for use by the tiering engine during a read operation (Block10). The file system stores this information from the tiering engine in the metadata it maintains for the ghosted range. The result of the ghosting operation is shown in FIG. 2B. File blocks [0-4], entries 202B and 204B, remain unchanged, but file blocks [5-9] are now consolidated into a single file layout map entry 206B and map to [Client1, Block10], indicating the identifier of the tiering engine and the storage location of the ghosted file extents for use by the tiering engine. To retrieve the ghosted extents, Client1 would request to read file blocks [5-9] of the file from the file system. The file system would determine that the file blocks are in a location known and managed by Client1 and would return the metadata [Client1, Block10] to indicate that the tiering engine, Client1, is responsible for retrieving the range of data. Client1 would verify the identifier is its own and then retrieve the data of the ghosted extent from its ghosted location—denoted by the metadata “Block10”.

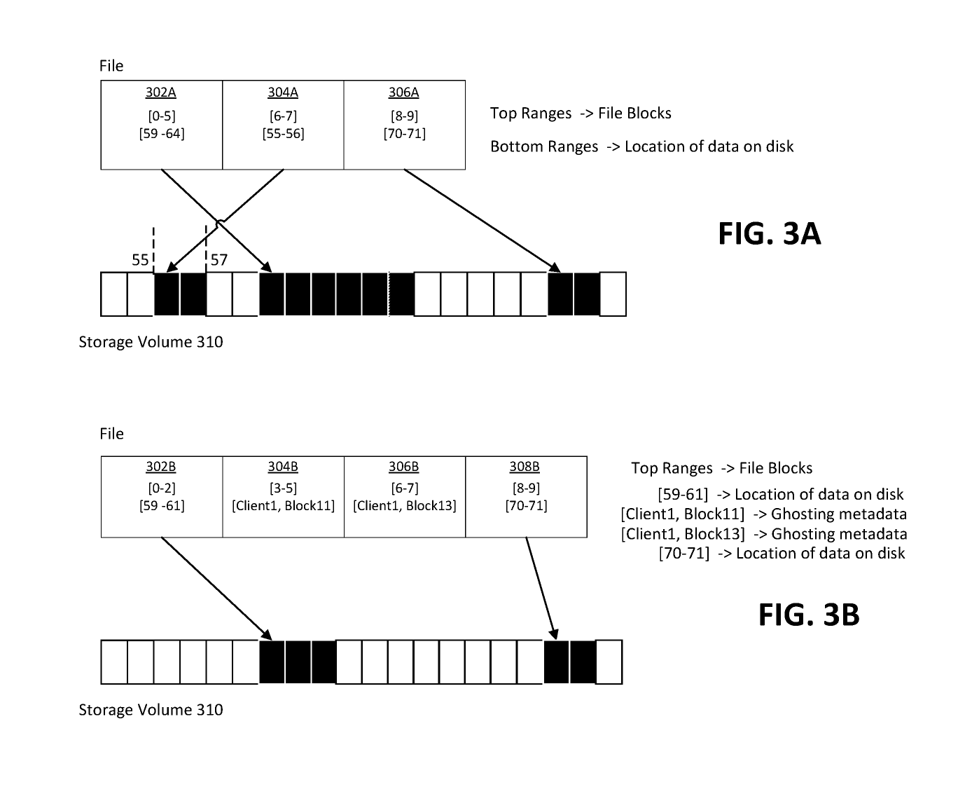

FIGS. 3A and 3B similarly illustrate another example of a file layout map before and after a ghosting operation. Again, in both figures, the top row of blocks represents a file layout map for a file having at least nine blocks, and the bottom row of blocks represents a storage volume (SV) 310 where the file blocks may be stored. In FIG. 3A, file layout map entry 302A contains metadata mapping file blocks [0-5] to SV[59-64], entry 304A contains metadata mapping file blocks [6-7] to SV[55-56], and entry 306A contains metadata mapping file blocks [8-9] to SV[70-71]. Similar to FIGS. 2A and 2B, above, a ghosting operation is performed by a tiering engine named “Client1” that ghosts file blocks [3-7]. The tiering engine will store ghosted extents [3-5] in “Block11” of its data store and ghosted extents [6-7] in “Block13” of its data store. The result of the ghosting operation is shown in FIG. 3B. The file layout map now has four entries. Entry 302B contains metadata mapping file blocks [0-2] to SV[59-61], entry 304B contains metadata mapping file blocks [3-5] to [Client1, Block11], entry 306B contains metadata mapping file blocks [6-7] to [Client1, Block13], and entry 308B contains metadata mapping file blocks [8-9] to SV[70-71]. Retrieving the ghosted file extents may be performed using a process identical to that for FIGS. 2A and 2B.

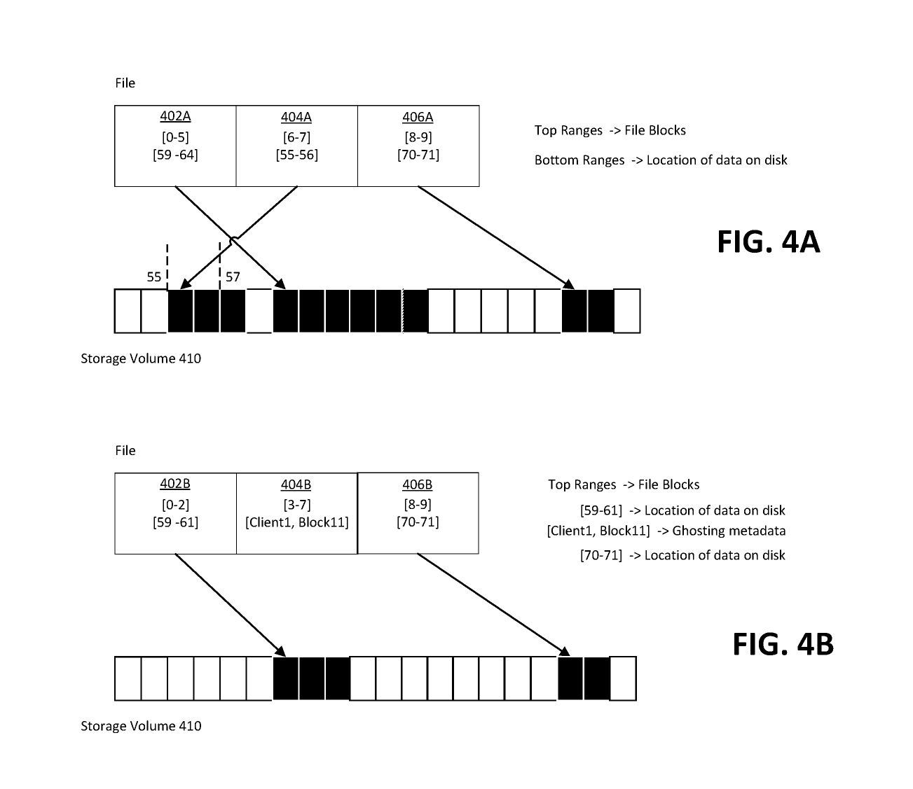

FIGS. 4A and 4B illustrate yet another example of a file layout map before and after a ghosting operation. In FIG. 4A, file layout map entry 402A contains metadata mapping file blocks [0-5] to SV[59-64], entry 404A contains metadata mapping file blocks [6-7] to SV[55-56], and entry 406A contains metadata mapping file blocks [8-9] to SV[70-71]. Similar to FIGS. 2A-B and 3A-B, above, a ghosting operation is performed by a tiering engine named “Client1” that ghosts file blocks [3-7]. The tiering engine will store ghosted extents [3-5] in “Block11” of its store. The result of the ghosting operation is shown in FIG. 4B. The file layout map still has three entries, but the entries have changed. Entry 402B contains metadata mapping file blocks [0-2] to SV[59-61], entry 404B contains metadata mapping file blocks [3-7] to [Client1, Block11], and entry 308B contains metadata mapping file blocks [8-9] to SV[70-71].

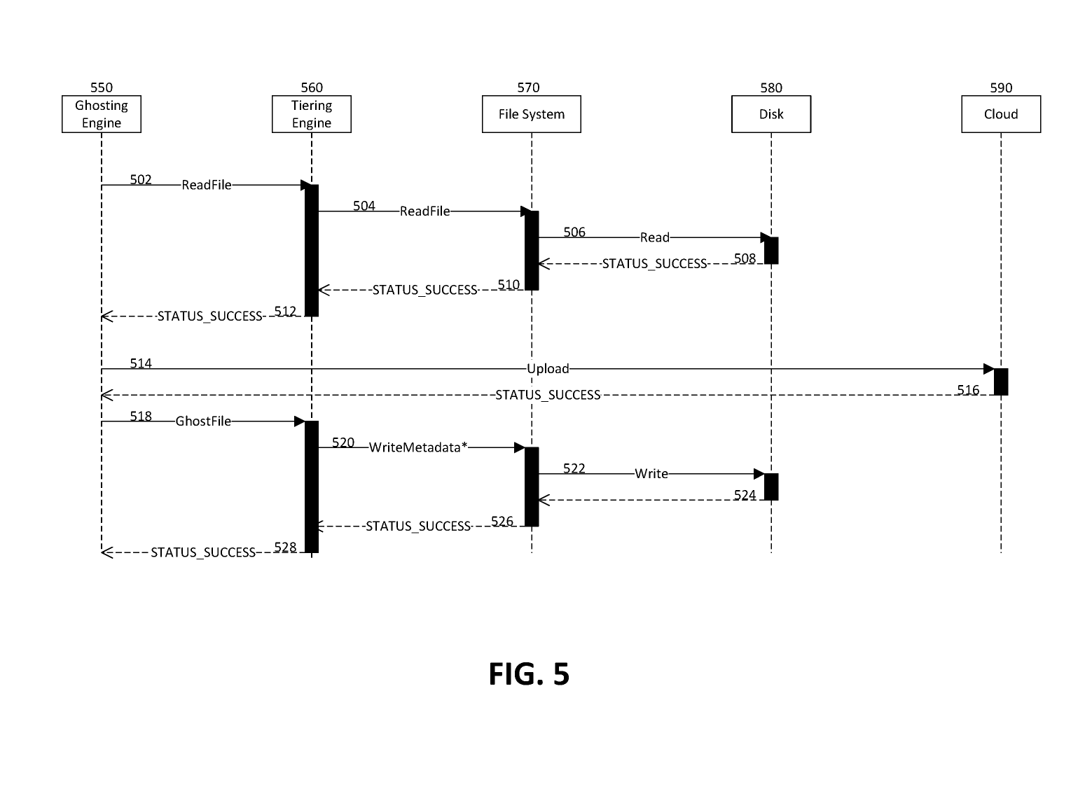

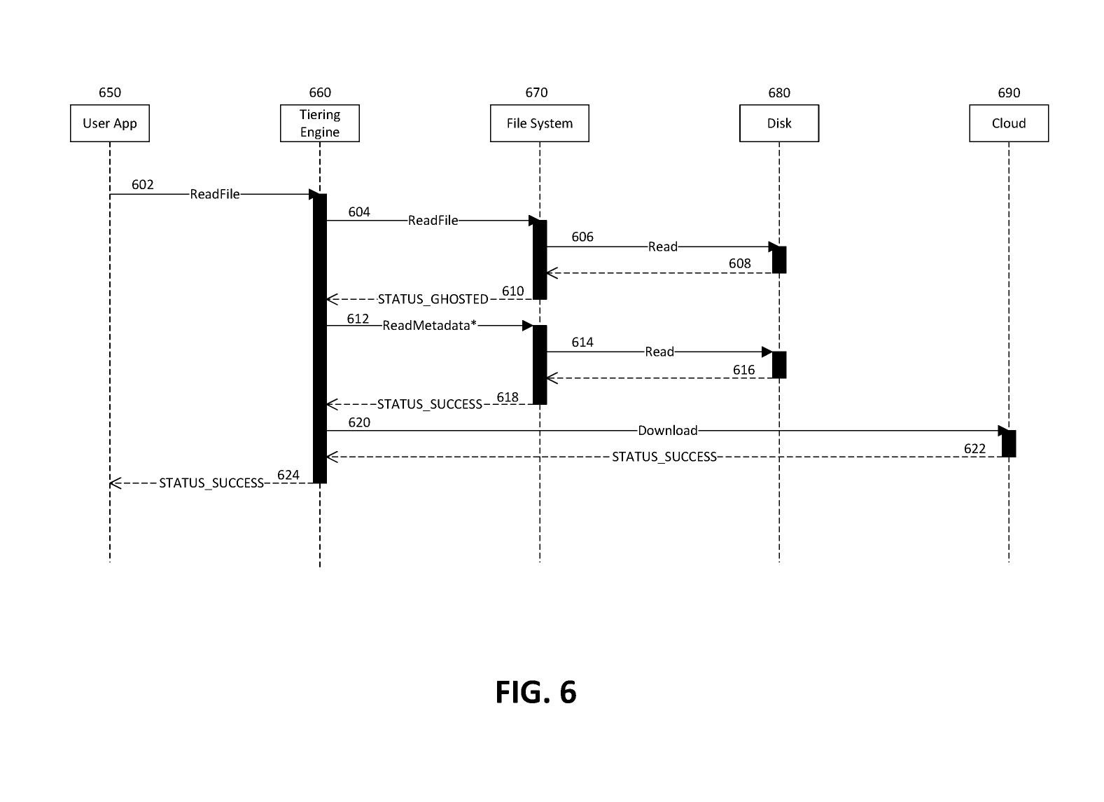

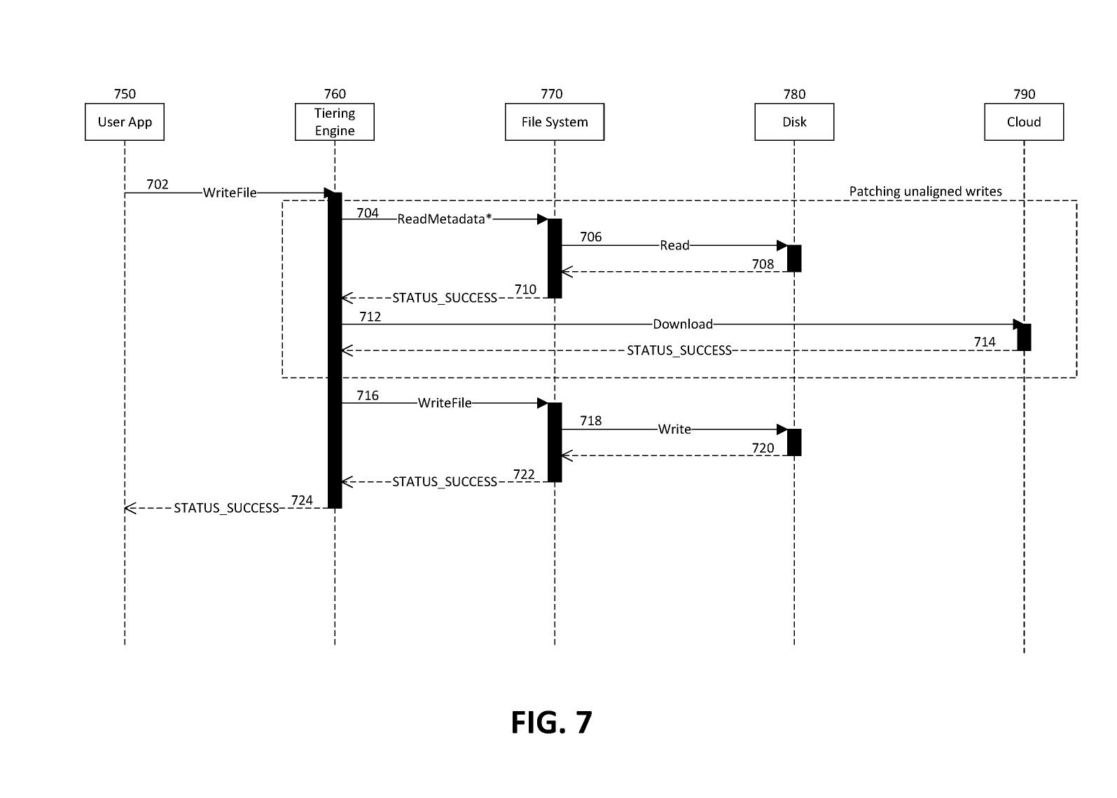

FIGS. 5-7 are call flows illustrating embodiments of the above-described ghosting methods in the context of a cloud tiering example. FIG. 5 illustrates an example call flow for ghosting a file extent, FIG. 6 illustrates an example call flow for reading a ghosted file, and FIG. 7 illustrates an example call flow for writing to a file that has been at least partially ghosted.

In particular, FIG. 5 illustrates an example call flow for ghosting a file extent using cloud tiering. This process may be performed by using the FSCTL ghosting-extents method introduced above. In this example, an additional client, ghosting engine 550, is involved in the ghosting process in addition to the tiering engine 560. The ghosting engine 550 may perform the processing functions of reading files and determining where file extents will be stored (i.e., the location the ghosted metadata will reference at the end of the ghosting process) to alleviate the tiering engine 560 from needing to perform these operations. The tiering engine 560 performs the reading and writing of file extents and metadata as described above.

When performing an initial ghosting operation, the file to be ghosted may be read in its entirety. At step 502, ghosting engine 550 performs a ReadFile operation and sends it to tiering engine 560. At step 504, tiering engine 560 has received the ReadFile request and passes it to the file system 570 to lookup the file's location metadata stored in the file system 570's file layout map. The file system 570 has received the read request and has located the file via its metadata. At step 506, the file system 570 reads the file from disk 580. Disk 580 may be any suitable local storage medium for storing file data, such as an HDD. At step 508, disk 580 replies with the file contents and a status indication that the file was read properly. At step 510, file system 570 has received the file and status indication and passes them back to tiering engine 560, which passes them to the ghosting engine 550 at step 512. After step 512 is completed, the ghosting engine 550 has possession of the contents of the file and may manipulate and store the file as needed.

At step 514, the ghosting engine 550 uploads the file to the cloud 590. Cloud 590 may be any suitable cloud storage location accessible to the ghosting engine 550. At step 516, the cloud 590 has received the uploaded file and replies to the ghosting engine 550 with a successful status indication that the file was saved.

To complete the ghosting process, the file system 570's file layout map must be updated with metadata as described above. At step 518, the ghosting engine 550 sends a GhostFile operation to the tiering engine 560, indicating that it has stored the file in the cloud 590. The tiering engine 560 creates metadata, as described above, to save in the file system 570's file layout map entry corresponding to the ghosted file. The metadata may include the tiering engine 560's identifier and additional metadata regarding the location at which the ghosted data is stored in the cloud 590. At step 520, the tiering engine 560 sends this metadata to the file system 570 using the WriteMetadata command. At step 522, the file system 570 writes the metadata to file's file layout map entry stored on disk 580, and at step 524, the disk 580 returns an indication the write was successful. After step 524, the file system 570's file layout map now contains metadata with an identifier of the tiering engine 560 and the additional metadata reflecting the actual location of the ghosted data, which the tiering engine 560 may later use to retrieve the ghosted data in response to, for example, a user application request to read the file. At step 526, the file system 570 informs the tiering engine 560 that the WriteMetadata operation was successful, and at step 528, the tiering engine 560 informs the ghosting engine 550 that the ghosting operation was successful. The file (or portion thereof) is now ghosted.

FIG. 6 illustrates an example call flow for reading a file, or portion of a file, that has been ghosted using cloud tiering, such as the file from FIG. 5. This process may be performed by using the FSCTL query-ghosted-extents method introduced above. The tiering engine 660, file system 670, disk 680, and cloud 690 may be the same entities as those seen in FIG. 5. In this example, a client, user app 650, is attempting to access the ghosted file. The tiering engine 660 may or may not have been the tiering engine that ghosted the file. Because the file was ghosted using cloud tiering, the cloud 690 may have a universal resource identifier (URI) that is accessible by any tiering engine capable of reading the metadata saved in file system 670's file layout map. However, if the file was ghosted using deduplication, instead of cloud tiering, the tiering engine 660 would likely need to be the tiering engine that ghosted the file because no such URI would exist.

At step 602, the user app 650 requests to read a file, or a portion of a file, and the request is passed to the tiering engine 660. At step 604, the tiering engine 660 requests to read the file from the file system 670. At step 606, the file system 670 reads the metadata associated with the file from its file layout map saved on disk 680. At step 608, the file system 670 determines that at least one range of data of the file is stored in a location known and managed by the tiering engine and is not located on disk 680 within the one or more data streams of the file, i.e., the at least one range is ghosted. At step 610, file system 670 indicates to the tiering engine 660 that the file (or at least one extent of the file) is ghosted. Steps 610-616 may not be needed in alternative embodiments where the file system 670 realizes that the tiering engine 660 is capable of reading the metadata of the ghosted file. However, for purposes of illustration, if the tiering engine 660 was not the tiering engine that ghosted the file, or if a different entity, such as the user app 650, was attempting to access the ghosted file without the proper tiering engine, it is clear that the file system 670 is able to return a status indication that the file is ghosted.

At step 612, the tiering engine 660 knows the file is ghosted and that it is responsible for retrieving the file data in order to fulfill the client user app 650's read request. The tiering engine 660 issues a ReadMetadata command to retrieve the metadata in the file system 670's file layout map entry for the file. At step 614, the file system 670 receives this request and issues a read request to its file layout map on the disk 680 to retrieve the metadata indicating the ghosted file's (or ghosted file extent's) location, and at step 616, the file system 670 receives the metadata from the disk 680. At step 618, the file system 670 sends the metadata and a status indication that the read was successful to the tiering engine 660.

Now, the tiering engine 660 may read the metadata to determine the ghosted file's location. In this example, the tiering engine 660 finds that the file is stored in cloud storage in the cloud 690. At step 620, the tiering engine 660 requests to download the file from the cloud 690, and at step 622, receives the file and a status indication that the download was successful from the cloud 690. Finally, at step 624, the tiering engine 660 sends the file to the user app 650 along with an indication that the initial read request from step 602 was successful. The user app 650 now has access to the file.

FIG. 7 illustrates an example call flow for writing to a file that has been at least partially ghosted using cloud tiering, as shown in FIG. 5, and read, as shown in FIG. 6. The user app 750, tiering engine 760, file system 770, disk 780, and cloud 790 may be the same entities as those seen in FIG. 6. In this example, the user app 750 has read a ghosted file and is attempting to make changes to the file and save them.

At step 702, the user app 750 requests to write to the at least partially ghosted file, and the request is passed to the tiering engine 760. The tiering engine 760 may perform different operations depending on the status of the file. If the modifications to the file were made in the portions saved to the file system 770 and the disk 780, then the tiering engine 760 may skip to step 716. However, if the modifications affected the file extents ghosted to the cloud 790, the tiering engine 760 may reunite the modified file extents of the file to one storage location. Otherwise, the content of file data may be saved incorrectly. This reuniting process is referred to as patching unaligned writes, as illustrated in FIG. 7. For example, if a file is ghosted as shown in FIG. 3B, and the user app 750 modifies a single byte in block [5], the tiering engine 760 must overwrite the data of the entire block because file systems are usually block-addressable. As a result, the tiering engine 760 must retrieve the ghosted extent that corresponds to block [5] to reunite the file for writing.

At step 704, the tiering engine 760 initiates the patching unaligned writes process by performing the read processes illustrated in steps 612-622 of FIG. 6. This may be performed by using the FSCTL query-ghosted-extents method, as described above. The tiering engine 760 issues a ReadMetadata command to retrieve the metadata in the file system 770's file layout map entry for the file. At step 706, the file system 770 receives this request and issues a read request to its file layout map stored on the disk 780 to retrieve the metadata indicating the ghosted file's location. At step 708, the file system 770 receives the metadata from the disk 780. At step 710, the file system 770 sends the metadata and a status indication that the read was successful to the tiering engine 760. The tiering engine 760 may read the metadata to determine the ghosted file's location. Again, the tiering engine 760 finds that the file is stored in the cloud 790. At step 712, the tiering engine 760 requests to download the file from the cloud 790, and at step 714, receives the file and a status indication that the download was successful from the cloud 790. Now, the tiering engine 760 has the extents of the file that were modified by the user app 750 and may write the modifications to the file maintained by the file system 770.

At step 716, the tiering engine issues a write command to the file system 770 to write the modifications to the file made by the user app 750, reuniting the previously ghosted extents with their one or more data streams in the process. At step 718, the file system 770 writes modifications to the file on local storage disk 780 and modifies the metadata in the file layout map entry for the file. At step 720, the file system is notified that the write was successful, and at step 722, sends a status indication that the write was successful to the tiering engine 760. At step 724, the tiering engine 760 then sends an indication that the write command issued in step 702 was successful.

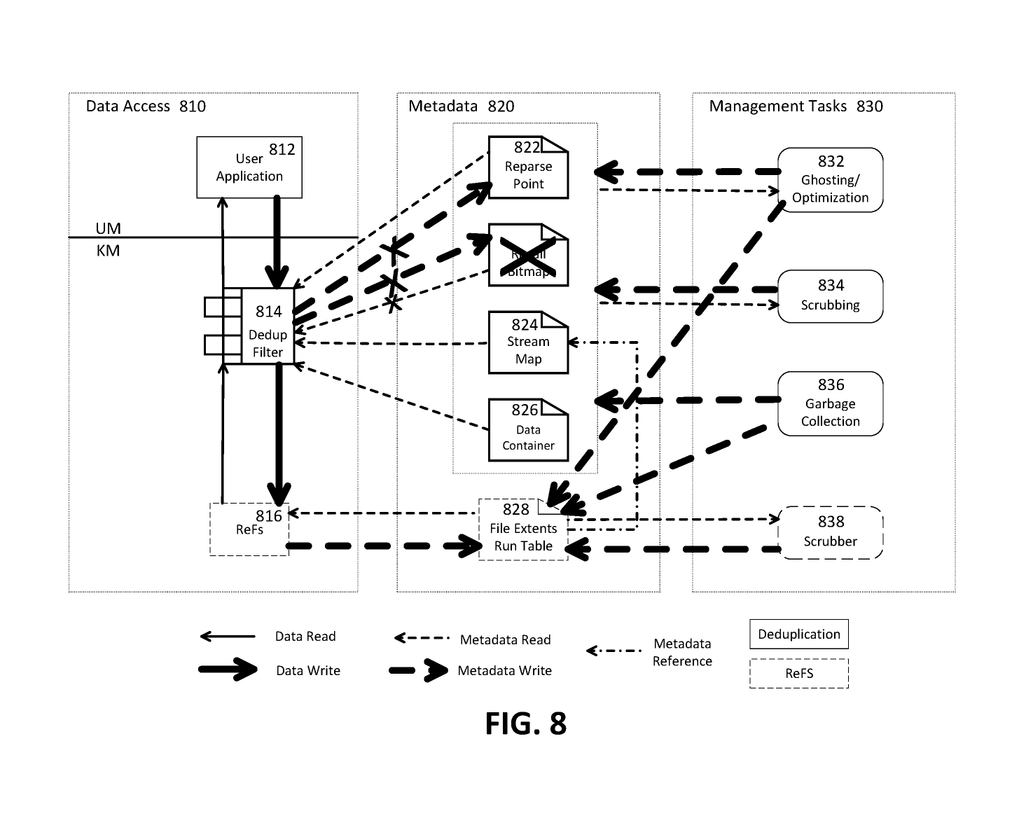

FIG. 8 illustrates an example architecture for implementing deduplication with the ReFS file system, in accordance with one embodiment of the ghosting aspects described herein. This architecture may implement the methods described above and allow ReFS to distinguish between ghosted extents and sparse extents. As described above, the tiering engine is responsible for reading and writing the metadata and storing a map containing the storage locations for ghosted extents.

FIG. 8 is divided into three blocks, Data Access 810, Metadata 820, and Management Tasks 830. The Data Access block 810 is further divided into user mode (UM) and kernel mode (KM). User mode refers to the interaction a user has with the system. For example, a user may use a user application 812 that may perform reads and writes to files on the file system. Here, the file system is ReFS 816. Kernel mode is handled by the operating system (OS) installed on the computing system implementing the architecture of FIG. 8. The actions in KM are unbeknownst to a user using the user application 812. When user application 812 attempts to issue read or write commands to ReFS 816, the command first passes through the dedup filter 814. Here, dedup filter 814 acts as a tiering engine, but is specific to deduplication. Having the dedup filter 814 act as an intermediary between ReFS 816 and user application 812 allows the dedup filter 814 to handle the ghosting before and after the user application 812 interacts with file data.

As illustrated in FIG. 8, dedup filter 814 interacts with the various components of the Metadata block 820. User files carry reparse points, stored in reparse point 822, that identify ghosted files. Stream map containers 824 hold chunk metadata and hashes for identifying where ghosted file extents are stored. Data containers 826 hold deduplicated data extents. The recall bitmap and associated metadata reads and writes, with an ‘x’ over their icons in the figure, are no longer necessary for implementing a deduplication system because ReFS 816 is able to track ghosted extents, as described above. The file extents run table 828 acts as the file layout map for ReFS 816, holding the map of file blocks to storage locations and/or metadata. The metadata in the file extents run table 828 holds references to the data in the stream map 824. Ghosted extents in the file extents run table 828 carry a fixed-size ID and a range (<offset, length>).

The Management Tasks block 830 provides components that help the ghosting process run more efficiently. The ghosting/optimization component 832 aids the dedup filter 814 in the post-processing deduplication process, much like the ghosting engine 550 of FIG. 5. The scrubbing component 834 periodically scans for and repairs errors in Dedup metadata. The garbage collection component 836 periodically reclaims freed disk spaces created by ghosting. The scrubber 838 periodically scans and repairs errors in the file extents run table 828.

ReFS 816 may be enabled to provide many aspects of the ghosting process and ease the burden on the dedup filter 814. ReFS 816 may provide a ghosting interface to mark ghosted extents with ghosted IDs and release the disk space of ghosted files at the same time. ReFS 816 may further provide a ghosted state query interface to the dedup filter 814 on the data access path to allow the dedup filter 814 to query the ghosted state of ReFS data files. ReFS 816 may store various ghosting parameters, such as a file's ghosted extent ID for example, in the file extent run table 828.

In alternative embodiments, ReFS 816 may store less information in the file extents run table 828. For example, extents in file extent run table 828 may carry a one-bit flag to indicate whether they are ghosted or not ghosted. In another example, ReFS816 may support multiple HSM tiering solutions coexisting on the same file by assigning each HSM tiering solution a unique owner ID, associating the unique owner ID with each ghosted range, and persisting the unique owner ID rather than using a one-bit flag in the file extent run table 828.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The various illustrative logical blocks, configurations, modules, and method steps or instructions described in connection with the aspects disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the present disclosure.

The various illustrative logical blocks, configurations, modules, and method steps or instructions described in connection with the aspects disclosed herein, or certain aspects or portions thereof, may be embodied in the form of computer executable instructions (i.e., program code) stored on a computer-readable storage medium which instructions, when executed by a machine, such as a computing device, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any non-transitory (i.e., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computer.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed:

1. In a computer system comprising a file system and storage local to the file system, the file system managing the storage and retrieval of files and storing the data of each file in one or more data streams, a method comprising:
maintaining, by the file system, for each of a plurality of files managed by the file system, metadata concerning one or more ranges of data of the file, the metadata including, for each range of data stored within the storage local to the file system, an indication of the storage location of the range of data within the local storage;
receiving, by the file system, from a tiering engine, a request indicating that a range of data of one of the files managed by the file system is stored by the tiering engine, not within the one or more data streams of the file, in a location known and managed by the tiering engine, the request comprising an identification of the range of the data and an identifier associated with the tiering engine; and
in response to the request, storing within the metadata maintained by the file system, for the identified range of data, an indication that the range of data is not stored within the one or more data streams of the file and the identifier associated with the tiering engine.

2. The method recited in claim 1, wherein the request from the tiering engine further comprises additional metadata, for use by the tiering engine, reflecting the storage location of the range of data not within the one or more data streams of the file, the method further comprising:
in response to the request, storing within the metadata maintained by the file system, for the identified range of data, the additional metadata received in the request.

3. The method recited in claim 1, further comprising:
receiving, by the file system via the tiering engine, a request from a client of the file system to access at least a portion of the contents of a file;
determining from the metadata maintained by the file system that at least one range of data of the requested portion of the file is stored by the tiering engine and not stored within the one or more data streams of the file; and
for the at least one range of data determined to be stored by the tiering engine and not stored within the one or more data streams of the file, returning an indication thereof to the tiering engine,
whereby the tiering engine is responsible for retrieving the range of data not stored within the one or more data streams of the file in order to fulfill the client request.

4. The method recited in claim 3, further comprising:
for any ranges of data of the requested portion of the file that are stored within the one or more data streams of the file, retrieving the data of those ranges from the local storage of the file system based on the metadata maintained for those ranges by the file system, and returning the data of those ranges to the tiering engine.

5. The method recited in claim 3, the client being a user application or a ghosting engine.

6. The method recited in claim 1, the location that is not within the one or more data streams of the file being a cloud storage location.

7. The method recited in claim 1, the method further comprising:
receiving, by the file system, from a second tiering engine, a request indicating that a second range of data of the file is stored by the second tiering engine in a location that is not within the one or more data streams of the file, the request comprising an identification of the second range of the data and an identifier associated with the second tiering engine; and
in response to the request, storing within the metadata maintained by the file system, for the second range of data, an indication that the second range of data is not stored within the one or more data streams of the file and the identifier associated with the second tiering engine.

8. The method recited in claim 1, further comprising:
after storing within the metadata maintained by the file system, for the identified range of data, an indication that the identified range of data is not stored within the one or more data streams of the file and the identifier of the tiering engine from which the request was received,
freeing disk space of the storage location of the identified range of data within the local storage of the file system.

9. The method recited in claim 1, further comprising:
receiving, by the file system via the tiering engine, a request from a client of the file system to write to at least a portion of the contents of a file;
determining from the metadata maintained by the file system that at least one range of data of the requested portion of the file is stored by the tiering engine and not stored within the one or more data streams of the file;
for the at least one range of data determined to be stored by the tiering engine and not stored within the one or more data streams of the file, returning an indication thereof to the tiering engine,
receiving, by the file system, from the tiering engine, the at least one range of data stored by the tiering engine;
storing, within the one or more data streams of the file, the received at least one range of data stored by the tiering engine;
storing, within the metadata maintained by the file system, for each of the received at least one range of data, an indication that the range of data is stored within the one or more data streams of the file; and
in response to the request, writing to the contents of the file.

10. The method recited in claim 1, further comprising:
receiving, by the file system via the tiering engine, a request from a client of the file system to delete the contents of a file;
determining from the metadata maintained by the file system that one or more ranges of data of the requested file are stored by at least one tiering engine and not stored within the one or more data streams of the file;
for the one or more ranges of data determined to be stored by the at least one tiering engine and not stored within the one or more data streams of the file, returning an indication thereof to the at least one tiering engine,
whereby the at least one tiering engine is responsible for deleting the one or more ranges of data not stored within the one or more data streams of the file; and
for any ranges of data of the requested file that are stored within the one or more data streams of the file, deleting the data of those ranges from the local storage of the file system and deleting the metadata maintained for those ranges by the file system.

11. A computing device comprising a processing unit, a memory, and a file system executing on the processing unit, the file system managing the storage and retrieval of files and storing the data of each file in one or more data streams, the file system when executing on the processing unit performing operations comprising:
maintaining for each of a plurality of files managed by the file system, metadata concerning one or more ranges of data of the file, the metadata including, for each range of data stored within a storage local to the file system, an indication of the storage location of the range of data within the local storage;
receiving, from a tiering engine, a request indicating that a range of data of one of the files managed by the file system is stored by the tiering engine, not within the one or more data streams of the file, in a location known and managed by the tiering engine, the request comprising an identification of the range of the data and an identifier associated with the tiering engine; and
in response to the request, storing within the maintained metadata, for the identified range of data, an indication that the range of data is not stored within the one or more data streams of the file and the identifier associated with the tiering engine.

12. The computing device recited in claim 11, wherein the request from the tiering engine further comprises additional metadata, for use by the tiering engine, reflecting the storage location of the range of data not within the one or more data streams of the file, in which the file system further performs operations comprising:
in response to the request, storing within the maintained metadata, for the identified range of data, the additional metadata received in the request.

13. The computing device recited in claim 11, in which the file system further performs operations comprising:
receiving, via the tiering engine, a request from a client of the file system to read at least a portion of the contents of a file;
determining from the maintained metadata that at least one range of data of the requested portion of the file is stored by the tiering engine and not stored within the one or more data streams of the file; and
for the at least one range of data determined to be stored by the tiering engine and not stored within the one or more data streams of the file, returning an indication thereof to the tiering engine,
whereby the tiering engine is responsible for retrieving the range of data not stored within the one or more data streams of the file in order to fulfill the client request.

14. The computing device recited in claim 13, in which the file system further performs operations comprising:
for any ranges of data of the requested portion that are stored within the one or more data streams of the file, retrieving the data of those ranges from the local storage of the file system based on the maintained metadata for those ranges, and returning the data of those ranges to the tiering engine.

15. The computing device recited in claim 13, the client being a user application or a ghosting engine.

16. The computing device recited in claim 11, the location that is not within the one or more data streams of the file being a cloud storage location.

17. The computing device recited in claim 11, in which the file system further performs operations comprising:
receiving, by the file system, from a second tiering engine, a request indicating that a second range of data of the file is stored by the second tiering engine in a location that is not within the one or more data streams of the file, the request comprising an identification of the second range of the data and an identifier associated with the second tiering engine; and
in response to the request, storing within the metadata maintained by the file system, for the second range of data, an indication that the second range of data is not stored within the one or more data streams of the file and the identifier associated with the second tiering engine.

18. The computing device recited in claim 11, in which the file system further performs operations comprising:
after storing within the metadata maintained by the file system, for the identified range of data, an indication that the identified range of data is not stored within the one or more data streams of the file and the identifier of the tiering engine from which the request was received,
freeing disk space of the storage location of the identified range of data within the local storage of the file system.

19. The computing device recited in claim 11, in which the file system further performs operations comprising:
receiving, by the file system via the tiering engine, a request from a client of the file system to write to at least a portion of the contents of a file;
determining from the metadata maintained by the file system that at least one range of data of the requested portion of the file is stored by the tiering engine and not stored within the one or more data streams of the file;
for the at least one range of data determined to be stored by the tiering engine and not stored within the one or more data streams of the file, returning an indication thereof to the tiering engine,
receiving, by the file system, from the tiering engine, the at least one range of data stored by the tiering engine;
storing, within the one or more data streams of the file, the received at least one range of data stored by the tiering engine;
storing, within the metadata maintained by the file system, for each of the received at least one range of data, an indication that the range of data is stored within the one or more data streams of the file; and
in response to the request, writing to the contents of the file.

20. The computing device recited in claim 11, in which the file system further performs operations comprising:
receiving, by the file system via the tiering engine, a request from a client of the file system to delete the contents of a file;
determining from the metadata maintained by the file system that one or more ranges of data of the requested file are stored by at least one tiering engine and not stored within the one or more data streams of the file;
for the one or more ranges of data determined to be stored by the at least one tiering engine and not stored within the one or more data streams of the file, returning an indication thereof to the at least one tiering engine,
whereby the at least one tiering engine is responsible for deleting the one or more ranges of data not stored within the one or more data streams of the file; and
for any ranges of data of the requested file that are stored within the one or more data streams of the file, deleting the data of those ranges from the local storage of the file system and deleting the metadata maintained for those ranges by the file system.
